(19) United States
(12) Patent Application Publication
(10) Pub. No.: US 2008/0192409 A1
(43) Pub. Date: Aug. 14, 2008

(54) LIVEBREAK FUSE REMOVAL ASSEMBLY FOR DEADFRONT ELECTRICAL APPARATUS

(76) Inventors: Paul Michael Roscizewski, Eagle, WI (US); Thomas Joseph Cahill, Delafield, WI (US); Timothy Allan Myers, Mukwonago, WI (US)

Correspondence Address: KING & SPALDING LLP, 1180 PEACHTREE STREET, ATLANTA, GA, 30309-3521, US

(21) Appl. No.: 11/674,228

(22) Filed: Feb. 13, 2007

(51) Int. Cl. H02B 7/00

(52) U.S. Cl. 361/605

(57) ABSTRACT

Assemblies for livebreak removal of fuse assemblies for deadfront electrical apparatus such as switchgear.

### BACKGROUND OF THE INVENTION

This invention relates generally to deadfront electrical apparatus and equipment, and more particularly to interfacing a deadfront electrical apparatus and power distribution cables through protective fuses.

Electrical power is typically transmitted from substations through cables which interconnect other cables and electrical apparatus in a power distribution network. The cables are typically terminated on bushings that may pass through walls of metal encased equipment and apparatus such as capacitors, transformers or switchgear.

Deadfront electrical apparatus is increasingly being used in lieu of livefront apparatus. A deadfront apparatus, as opposed to livefront apparatus, has no exposed voltage on the exterior of the apparatus and therefore provides increased, safety for both the apparatus operator and the public. The deadfront system also provides easy and efficient operation of the apparatus with a one or two man crew, for example, and also provides enhanced operator safety by virtue of grounded visible break connection points, or with load-break connection points. The deadfront system has proven to be extremely reliable with very low failure rate.

Cables connected to deadfront apparatus are sometimes protected with fuses. When specified electrical conditions occur, the fuse operates to open the electrical connection between the deadfront apparatus and the cable. Disconnecting fuses under electrical load for high voltage switchgear, however, is difficult. Large forces are typically required to pull the fuse from the deadfront apparatus. Overcoming large extraction forces in a safe manner for replacement of fuses under electrical stress at high voltages is of particular concern.

### BRIEF DESCRIPTION OF THE DRAWINGS

FIG. 1 is a partial perspective view of a deadfront electrical apparatus including a livebreak fuse removal assembly according to an exemplary embodiment of the invention in a closed position.

FIG. 2 is a partial perspective view of the electrical apparatus shown in FIG. 1 with the livebreak fuse removal assembly in an opened position.

FIG. 3 is a partial perspective view of a deadfront electrical apparatus including a livebreak fuse removal assembly according to another exemplary embodiment of the invention in a closed position.

FIG. 4 illustrates the electrical apparatus and fuse removal assembly of FIG. 3 illustrating further components thereof.

FIG. 5 is a magnified partial perspective view of a portion of the assembly shown in FIG. 3.

FIG. 6 is a side elevational view of the assembly shown in FIG. 5.

FIG. 7 is a partial perspective view of the apparatus and fuse assembly shown in FIG. 3 in an opened position.

FIG. 8 is a perspective view of another embodiment of a fuse removal assembly and electrical apparatus.

### DETAILED DESCRIPTION OF THE INVENTION

Embodiments of a livebreak fuse removal assembly and system are provided that aids in overcoming large extraction forces for removal of fuses under electrical load at high voltages are provided. The livebreak fuse removal assembly provides deadfront protection for encapsulated fuses coupled to, for example, molded switchgear.

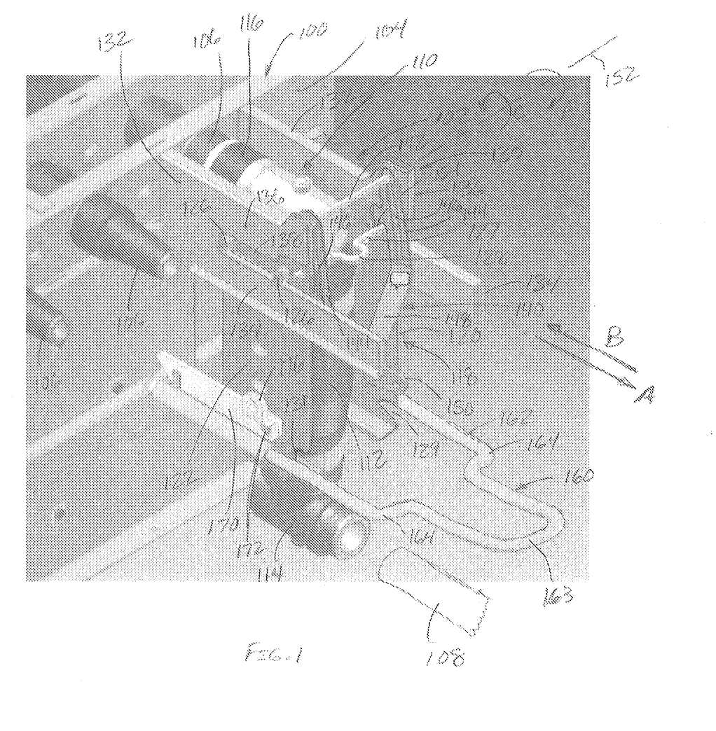

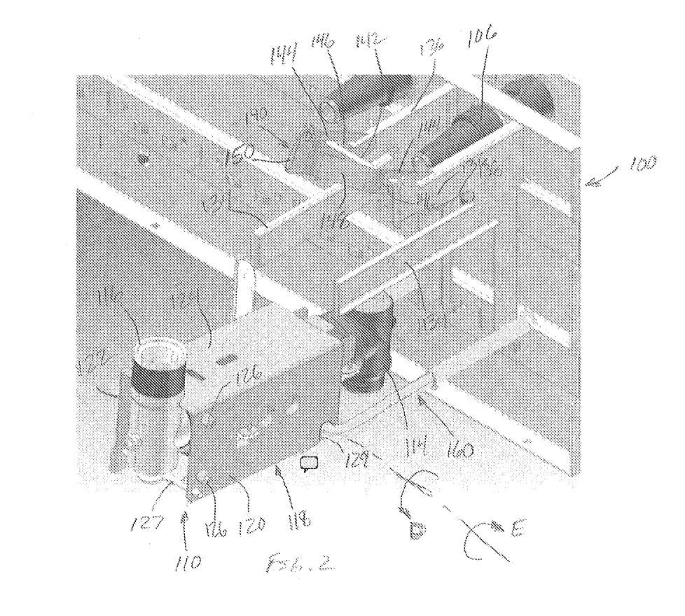

FIG. 1 is a partial perspective view of a deadfront electrical apparatus 100 including a livebreak fuse removal assembly 102. The fuse removal assembly 102 is selectively positionable between a closed position as shown in FIG. 1, and an open position shown in FIG. 2.

The electrical apparatus 100 in an exemplary embodiment may be a high voltage (e.g. 5 kV-38 kV) switchgear equipment used to distribute and control electrical power distribution, although it is appreciated that the apparatus 100 may be another type of electrical apparatus in another embodiment while substantially benefiting from the fuse removal system 102 of the invention as explained below. The fuse removal assembly 102 is generally applicable to and beneficial for any type of high voltage apparatus and equipment wherein fuse protection is desirable.

The switchgear 100 may be padmounted or underground switchgear having an enclosure or container 104 that houses, for example, bushings 106, insulation, a bus bar system, and a collection of active switching elements. The active switching elements may include internal active components, such as a fuse, a switch, or an interrupter and external points of connection, such as the bushings 106, to establish line and load connections to an electrical distribution system. The active switching elements in the switchgear may be used to open and/or close one or more circuit paths through the switchgear 100 automatically, manually, or remotely. The bushings 106, in turn, couple to, or form an integral part of, the active switching elements inside the switchgear 100. The active switching elements may be coupled together by a bus bar system in the switchgear 100.

In one embodiment, the switchgear 100 may be an Edison® Modular Switchgear commercially available from Cooper Power Systems of Pewaukee, Wis. Such modular switchgear may be a fused or vacuum, fault-interrupter switchgear utilizing solid-dielectric EPDM insulation. The dielectric insulation enables the switchgear to be more compact, with a lower profile than air-insulated designed switchgear. Additionally, such modular switchgear is lighter than oil or gas-insulated switchgear, making it easier to install and more environmentally friendly than other types of switchgear.

While specific exemplary switchgear 100 has been described, it is understood that the benefits of the invention accrue generally to switchgear of many configurations, and that the switchgear 100 is but one potential application of the fuse removal assembly 102 described hereinbelow. For example, instead of pad-mounted or subsurface switchgear, the switchgear 100 may be used on an overhead distribution system or used in a vault below grade or within load-rooms inside buildings. Such types of switchgear may share similar structural and operational components to padmounted switchgear, but are mounted slightly differently and may be connected differently to an electrical power transmission system. Additionally, switchgear having non-solid dielectric insulation, such as air, gas or oil, may likewise be employed in other embodiments. The switchgear 100 is therefore illustrated and described herein for illustrative purposes only, and the invention is not intended to be limited to any particular type of switchgear configuration, such as the switchgear 100 described above.

Distribution cables 108 are connectable to the bushings 106 via encapsulated fuse assemblies 110 (one of which is shown in FIG. 1) to transmit power at high voltages. The encapsulated fuse assemblies 110 may include a main body 112 having a fuse link or fuse element assembly that is encapsulated in epoxy or ethylene propylene diene monomer (EPDM) rubber insulation, for example, with integral terminals in the form of bushing interfaces 114, 116 on opposing ends of the main body 112. One of the bushing interfaces 114 or 116 may be, for example a male bushing interface, while the other of the interface 114 or 116 may be a female bushing interface. The fuse in the main body 112 may be, for example, an encapsulated current limiting fuse having a fuse element therein that opens, disintegrates or otherwise structurally fails, thereby opening an interrupting a current path through the fuse element when specified current conditions occur.

In the illustrated embodiment, the bushing interface 114 may be coupled to the distribution cable 108 using a known bushing connector, for example, and the bushing interface 116 may be coupled to one of the bushings 106 of the electrical apparatus 100. The encapsulated fuse assemblies 110 may also be provided with base assemblies 118, sometimes referred to as shrouds, that include spaced apart side walls, panels or plates 120, 122. A connecting plate 124 (FIG. 2), sometimes referred to as a mounting plate, extends between the side plates 120, 122 to provide a three sided enclosure about the encapsulated fuse assembly 110. The base assembly 118 in each encapsulated fuse assembly 110 may be fabricated from molded dielectric materials in an exemplary embodiment.

The fuse assembly 110 may be a pre-packaged Edison® modular fuse product, also available from Cooper Power systems Pewaukee, Wis., including the mounting base 124 and terminal bushings 114, 116 or elbows connected to the fuse in the main body 112. One of the terminal bushings or elbows may be a load-break bushing interface 116 familiar to those in the art, while the other interface may be a load-break or dead-break bushing interface 114 as desired. Alternatively, the interfaces may be other types of bushing interfaces, including but not limited to interfaces adapted to make and break electrical connections that are energized at rated voltage, but not carrying load current.

The load break interface 116 of the fuse assembly 110 connects to a load-break bushing 106 on the switchgear 100, while the interface 114 connects to the distribution cable 108. As such, the load-break interface 116 defines a source or line-side connection to the fuse when the switchgear 100 is energized and receiving electrical power, while the interface 114 defines a load-side connection to the fuse. When the fuse element in the fuse opens, the conductive path through the fuse from the line-side interface 116 to the load-side interface 114 is broken, protecting electrical components and equipment connected to the load side interface 114 from potentially damaging current. Therefore, when the fuse opens, the load-side interface 114 is electrically isolated from the line-side interface 116, and components, equipment and circuitry connected to the load-side interface 114 no longer receive electrical power from the switchgear 100. The fuse assembly 110 must be replaced to restore the electrical connection and to feed power to load-side devices. Removal of the fuse assembly 110 when the line-side interface 116 is under electrical stress, however, is challenging due to large extraction forces required to pull the line-side interface 116 from the energized bushing 106 of the switchgear 100 at high voltage.

As shown in FIGS. 1 and 2, to overcome problems relating to high extraction forces needed to remove the fuse assembly 110, each side plate 120, 122 may be provided with supports such as cylindrical rollers 126 projecting outwardly from each plate 120, 122. Also, an extraction bar 127 may extend between the side plates 120 and 122 for removal of the fuse assembly 110 from the switchgear 100 in the manner explained below. The extraction bar 127 may be formed with a bend or loop 128 to facilitate actuation of the bar 127 with an insulated tool or rod, sometimes referred to as a hotstick to those in the art. The extraction bar 127 in an exemplary embodiment is located at the upper end of the fuse assembly 110 as shown in FIG. 1, although it could be provided at other locations in other embodiments. Notches or slots 129 and 131 may be provided at the lower corners of the side panels 120 and 122.

To facilitate mounting and removal of the fuse assembly 110 from the switchgear 100, a fuse mounting bracket assembly 130 is coupled to a front panel of the switchgear enclosure 104. The mounting bracket assembly 130 defines spaced apart, mirror image bracket members 132 each defining a rail portion 134 and a lever portion 136. The rail portions 134 and the lever portions 136 define a fuse mounting slot 138 therebetween. The slot 138 receives the rollers 126 of the side plates 120, 122 of the fuse assembly 110. The rollers 126 are moveable, slidable, or otherwise positionable on the rail portions 134 within the slots 138 in the directions of arrows A and B when the fuse assembly 110 is released from the bushing 106. The rail portions 134 support the fuse assembly 110 via the rollers 126. The bracket members 132 may be fabricated from a molded dielectric material, for example, and may be fixed, mounted or otherwise attached to the switchgear enclosure 104 using known techniques.

A pivotal fuse removal lever or linkage 140 may be mounted to the lever portions 136 of the mounting bracket members 132 via a connecting bar or rod 142 extending between the lever portions 136. The linkage 140 may include generally spaced apart lever arms 144 each having a longitudinal slot 146 therein, and a generally V-shaped bridge portion 148 extending from the respective ends of the lever arms 144 and culminating in a single engagement tab 150 having an opening therein that may be accessed with an insulating rod or hotstick. The connecting bar 142 is received within each respective slot 146 in the lever arms 144 and the arms 144 are slidable over the surface of the connecting bar 142. Thus, when the engagement tab 150 is pulled outwardly in the direction of arrow A, the linkage 140 may be rotated about an axis 152 of the connecting bar 142 in the direction of arrow C as the slots 146 are slid over the surface of the bar 142.

One or both of the lever arms 144 may include a catch surface 154 that, as the linkage 140 is pivoted in the direction of arrow C, engages the extraction bar 127 of the fuse assembly 110. When the catch surface 154 of the arms 144 engages the extraction bar 127 while the linkage 140 is being pivoted, the linkage 140 pulls the extraction bar in the direction of arrow A away from the bushing 106 to disengage or separate the load break interface 116 from the bushing 106. Once the load-break bushing 116 is disengaged from the switchgear bushing 106, the linkage 140 may be pivoted upwardly and away from the fuse assembly 110 to an opened position as shown in FIG. 2.

A cradle or catch hoop 160 may be provided and attached to the deadfront enclosure 104 near the lower end of the fuse assembly 110. The cradle 160 may include a first portion 162 defining a larger opening and a second portion 163 defining a smaller opening extending away from the enclosure 104.

When the load-break bushing interface 116 of the fuse assembly 110 is released from the switchgear bushing 106, the fuse assembly 110 may be pulled, via the extraction loop 128 outwardly in the direction of arrow A with the rollers moving or sliding on the bracket member rails 134 for the axial length of the rails. When the rollers 126 meet the end of the rails 134, the corner slots 129, 131 in the side plates 120 and 122 of the fuse assembly 110 engage corners 164 of the cradle 160 between the cradle portions 162 and 164. In such a position, and as shown in FIG. 2, the fuse assembly 110 may be pivoted about the corner slots 129 and 131 to a resting position wherein the main body 112 of the fuse assembly 110 is supported on the second portion 163 of the cradle 160. A protective cap may be securely latched to the exposed and live switchgear bushing 106. A lineman may remove the fuse from the fuse assembly 110 away from the switchgear and a new fuse assembly including a replacement fuse may be positioned on the cradle 160 by hand.

Once the fuse is replaced, the fuse assembly 110 may be placed onto the second portion 163 of the cradle 160 as shown in FIG. 2, and the protective cap may be removed from the switchgear bushing 106. Using a hotstick, for example, the fuse assembly 110 may then be rotated about the corner slots 129, 131 in the direction of arrow E, opposite to the direction of arrow D, until the rollers 126 in the side plates 120 and 122 are again supported on the rails 134 of the bracket members 132. In such a position, a hotstick may be used to push the extraction bar 127 of the fuse assembly 110 to slide the protrusions upon the rails 134 and move the load-break bushing 116 toward the switchgear bushing 106, and the linkage 140 may be rotated back in the direction of arrow F (FIG. 1) to firmly engage and lock the load-break bushing 116 to the switchgear bushing 106. The cradle 160 may be removable from the switchgear enclosure 104 when not in use.

A locking latch bracket 170 may also be provided and may be connected to one of the side plates 120, 122 of the fuse assembly 101. An end of the latch bracket 170 may be hooked over a portion of one of the bracket members 132 or the enclosure 104 to prevent relative movement of the fuse assembly 110 upon the rails 134 in the direction of arrow A unless first released from the bracket member 132. The locking latch bracket 170 may be pivotally attached to the side plate 122 for example at a pivot point 172, and the latch bracket 170 may be pivoted with a hotstick using an engagement tab 176 formed on the latch bracket 170 to unlock the latch bracket 170 so that the fuse assembly 110 can be removed, or to lock the latch bracket 170 to prevent removal of the fuse assembly 110.

Additionally, the latch bracket 170 in a further embodiment may define one or more controlled stops that would prevent the fuse assembly 110 from being disengaged from the switchgear bushing 106 beyond a predetermined amount. In such a manner, for example, the latch bracket would permit sufficient disengagement to break the seal between the load-break bushing interface 116 and switchgear bushing 106, without exposing conductive portions of either the bushing interface 116 or the switchgear bushing 106 for an added degree of safety.

Removal and replacement of the fuse is therefore provided in a safe and efficient manner that utilizes mechanical leverage in the linkage 140 to remove the fuse assembly 110 from the switchgear 100 with a comparatively low amount of extraction force than would otherwise be required to separate the load-break bushing 116 from the switchgear bushing 106.

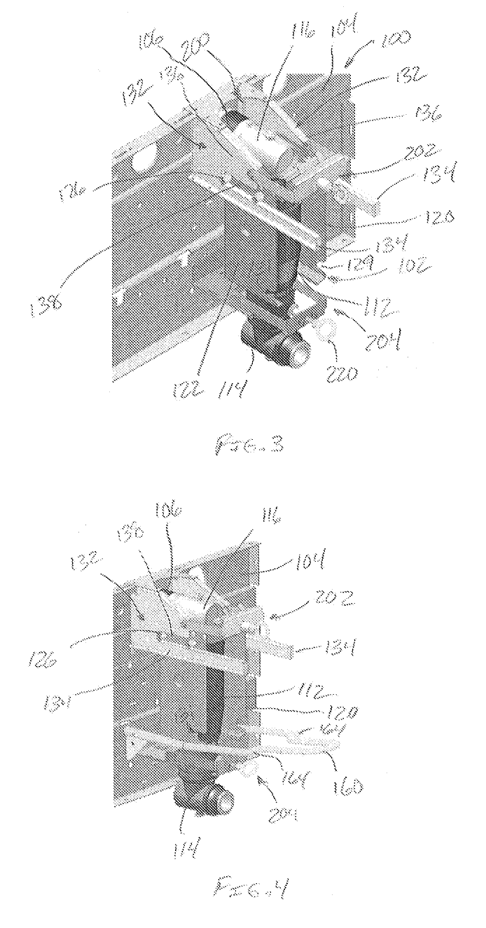

FIG. 3 is a partial perspective view of the deadfront electrical apparatus 100 including the encapsulated fuse assembly 110 and another livebreak fuse removal assembly 200 according to another exemplary embodiment of the invention that also facilitates safe and efficient fuse removal with a reduced amount of extraction force.

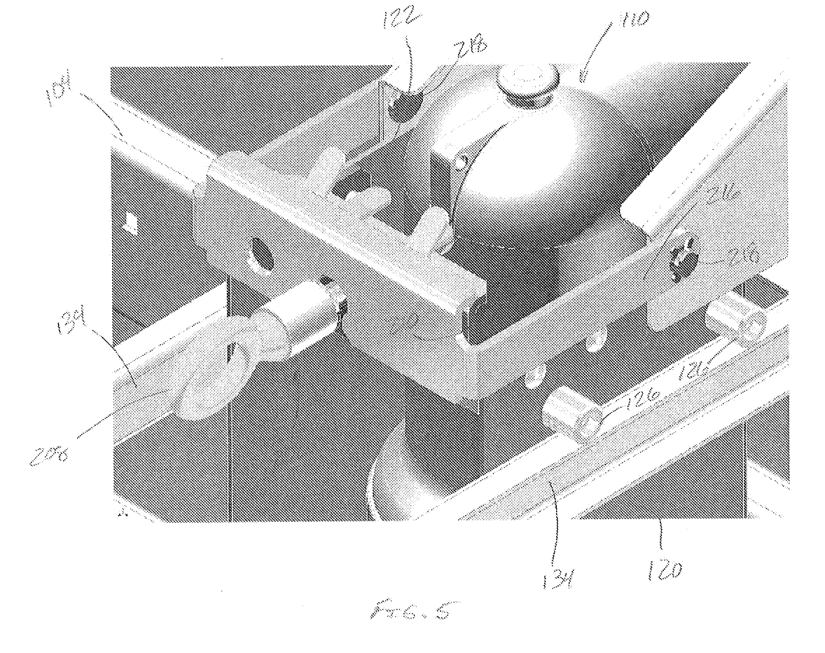

Like the foregoing embodiment, the fuse removal assembly includes bracket members 132 connected to the switchgear enclosure 104, and each bracket member 132 defines a rail portion 134 and a lever portion 136. A slot 138 extends in each bracket member 134 so that the fuse assembly rollers 126 may be received in the slots 138 and supported on the rails 134. The cradle 160 (FIG. 4) is also removable connectable to the switchgear enclosure 104.

Unlike the embodiment depicted in FIGS. 1 and 2, however, the removal assembly 200 includes a threaded actuator element 202 in lieu of the linkage 140, and a threaded latch element 204 in lieu of the locking latch bracket 170.

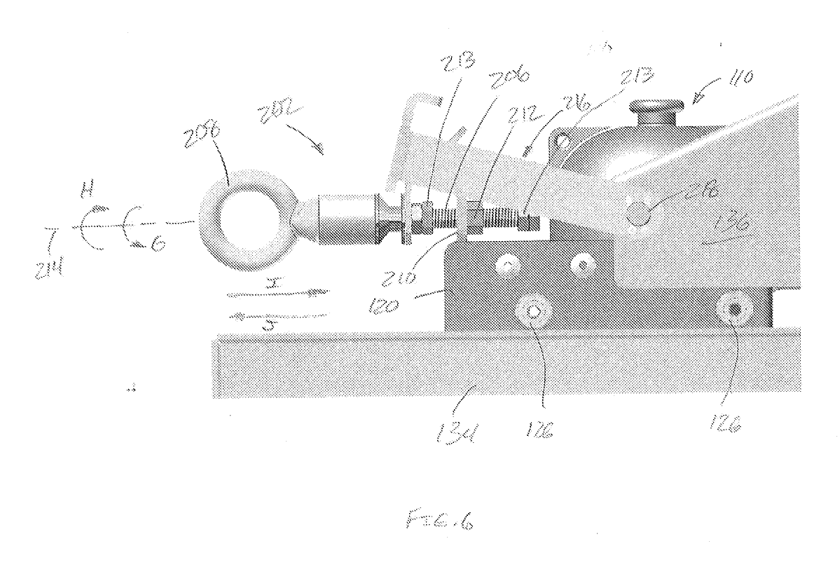

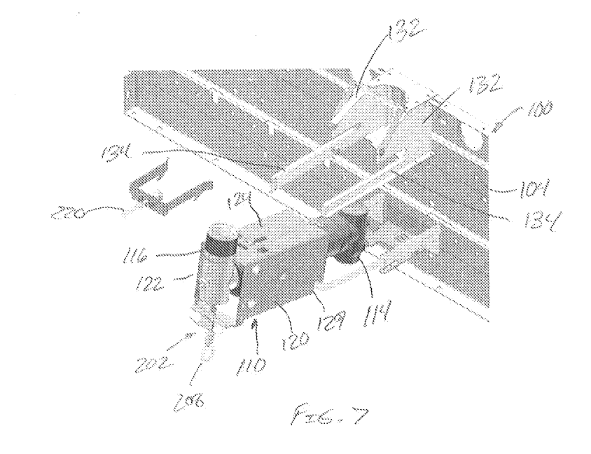

FIGS. 5 and 6 illustrate the threaded actuator element 202. The actuator element 202, as shown in FIGS. 5 and 6, may include a threaded shaft 206, a pulling eye 208 coupled to the shaft 206 and a connecting extension 210 that is mounted stationary between the side plates 120 and 122 of the fuse assembly 110. A nut 212 (FIG. 6) is mounted stationary to the extension 210, such as via welding techniques, and jam nuts 213 may be provided and fixed to the shaft 208. Consequently, as the eye 208 is held captive and is rotated to turn the shaft 206 about its longitudinal axis 214 with, for example, an insulating rod or hotstick, the fuse assembly 110 is moved toward and away from the switchgear bushing 106.

In the illustrated example, when the shaft 206 is turned clockwise in the direction of arrow G the fuse assembly 110 is moved in the direction of arrow I toward the switchgear bushing 106 and the switchgear enclosure 104 with the rollers 126 moving upon the rails 134 in the direction of arrow I. In contrast, when the shaft 206 is turned counter-clockwise in the direction of arrow H the fuse assembly 110 is moved in the direction of arrow J away from the switchgear bushing 106 and the switchgear enclosure 104 with the rollers 126 moving upon the rails 134 in the direction of arrow J. The jam nuts 213 effectively limit and control the movement of the fuse assembly 110 within a predetermined range. That is, the jam nuts 213 preclude movement of the fuse assembly 110 in the direction of arrows I and J beyond a predetermined amount.

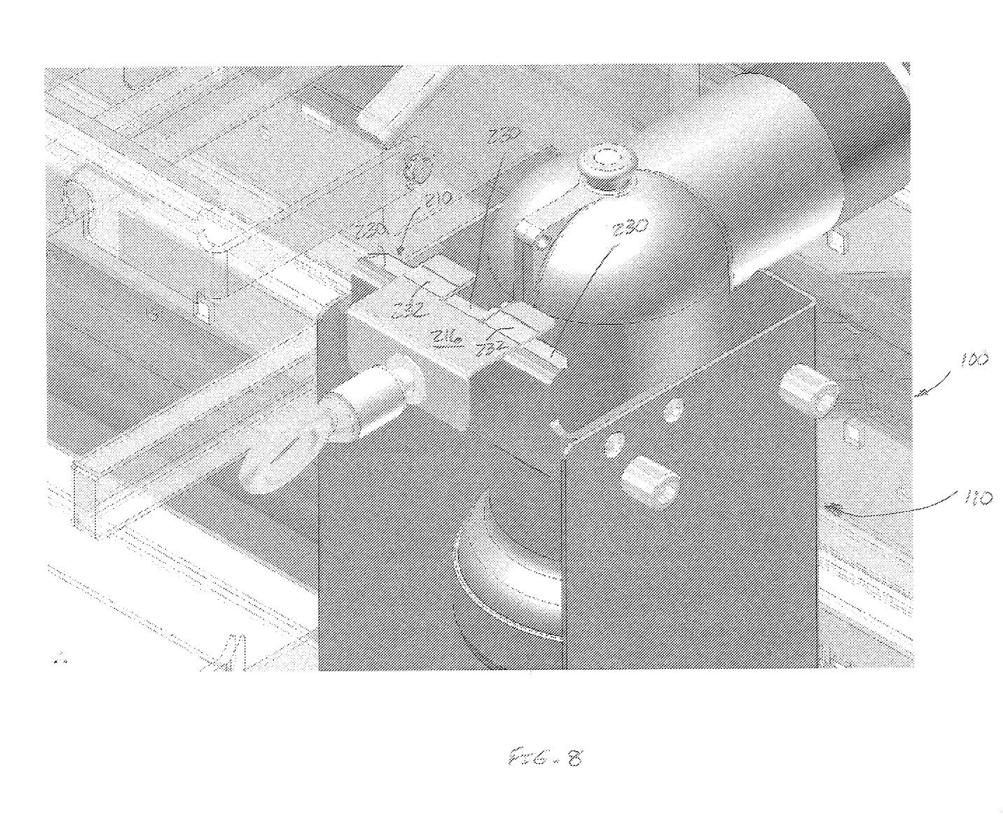

The distance that the fuse assembly 110 is moved upon the rails in either the direction of arrow I or J may be finely adjusted with the relative positions of the jam nuts 213 and by varying the number of turns of the eye 208 to rotate the shaft 206 about its axis 214. In particular, in one exemplary embodiment, the eye 208 may be fully turned clockwise in the direction of arrow G to advance the fuse assembly 110 upon the rails 134 in the direction of arrow I until the load-break bushing 116 and the switchgear bushing 106 (FIGS. 4 and 5) are completely engaged. To disengage the load-break bushing 116 from the switchgear bushing 106 the eye 208 may be turned counterclockwise in the direction of arrow H for about two full turns to move the fuse assembly 110 upon the rails 134 in the direction of arrow I for a sufficient distance to break the seal between the bushings 116 and 106, but insufficient to expose the electrical contact of either bushing. A U-shaped lever 216 is connected to the lever portion 136 of the bracket members 132 at pivot points 218 so that the lever 216 may be pivoted upwardly and away from the threaded actuator 202 as shown in FIGS. 6 and 7.

Once the seal between the bushing 116 and the switchgear bushing 106 is broken and after the lever 218 has been pivoted away from the actuator 202, the eye 208 may be pulled in the direction of arrow I with a hotstick to move the rollers 126 to the end of the rails 134. The corner slots 129 and 131 of the fuse assembly side plates 120, 122 at this position engage the corners 164 of the cradle 160 and the fuse assembly 110 may be pivoted about the corner slots to a resting position upon the cradle 160 as shown in FIG. 7. A protective cover or cap may be placed over the switchgear bushing 106, and the fuse assembly 110 may then be removed by hand and the fuse link may be replaced.

When the fuse assembly 110 is again placed upon the cradle 160, the assembly 102 may be pivoted back about the corner slots 129 and 131 and the actuator 202 may be threaded to fully engage the load-break bushing 116 to the switchgear bushing 106. The lever 216 may be pivoted back down to its closed position as shown in FIGS. 3 and 4.

As also illustrated in FIGS. 3, 4 and 7, a threaded latch element 204 may optionally be provided near the lower end of the fuse assembly 110 to prevent removal of the fuse assembly 110. The latch element also includes an eye 220 that may be turned in a clockwise or counter-clockwise direction to move a threaded shaft toward and away from the fuse element assembly 102. The eye may also be used to remove the threaded latch element 204 from the assembly with, for example, a hotstick.

Additionally, and as shown in FIG. 8, alignment features may be provided on the extension 210 and on portions of the lever 216 so that the actuator element 202 may be manipulated to a precise and predetermined level of engagement of the load-break bushing 116 and the switchgear bushing 106. As such, by aligning certain features of the extension 212 with certain features of the lever 216, the actuator 202 may be operated to achieve an optimum degree of engagement between the bushings 116 and 106. As one example, the extension 210 and the lever 216 may include color coded stripes 230 and 232 so that when the stripes 230 and 232 are aligned with one another the stripes 230 and 232 indicate that the desired degree of bushing engagement has been obtained. Alternatively, the stripes 230 and 232 when aligned may provide a visible break that the mating contacts in the bushing have been disengaged. More than one stripe 230 and 232 may be provided on each of the extension 210 and the lever 216 if desired to visually indicate latched or unlatched positions.

The foregoing embodiments facilitate safe, efficient, and controlled livebreak fuse removal with reduced extraction forces.

An embodiment of a deadfront electrical apparatus is disclosed herein. The apparatus comprises: an enclosure; a high voltage bushing extending from the enclosure; a fuse mounting bracket coupled to the enclosure proximate the high voltage bushing; a fuse assembly connected to the high voltage bushing and being selectively positionable between a closed position supported by the mounting bracket, and an open position, the fuse comprising a bushing interface; and a fuse removal assembly adapted to separate the bushing interface from the high voltage bushing under energized circuit conditions.

Optionally, the fuse removal assembly comprises a pivotal linkage mounted to the fuse mounting bracket. The fuse removal assembly may comprise a threaded actuator element. The fuse removal assembly further may also comprises a fuse cradle mounted to the enclosure adjacent the fuse bracket. A latch element may be provided, with the latch element preventing removal of the fuse when in a locked position. The fuse assembly may include opposing side walls and a fuse extending between the side walls, with at least one of the side walls comprising a cradle pivot slot. The mounting bracket may comprise a rail, with the fuse assembly being movable along the rail. The apparatus may comprise solid dielectric switchgear. The fuse removal assembly may include a visible latch indicator.

Another embodiment of a high voltage electrical apparatus is also disclosed. The apparatus comprises: an enclosure; a high voltage bushing accessible on the enclosure; a fuse mounting bracket coupled to the enclosure proximate the high voltage bushing; a cradle coupled to the enclosure proximate the mounting bracket; and a fuse assembly connected to the high voltage bushing and being selectively positionable between a closed position supported by the mounting bracket and an open position supported by the cradle, the fuse assembly comprising a bushing interface configured for making and breaking a high voltage connection to the bushing; wherein the fuse is pivotal about the cradle to the open position.

Optionally, the apparatus further comprises a pivotal linkage adapted to separate the bushing interface from the high voltage bushing under energized circuit conditions. The apparatus may also comprise a threaded actuator element adapted to separate the bushing interface from the high voltage bushing under energized circuit conditions. The fuse assembly may comprise a turning eye. The fuse removal assembly may further comprise a latch element, with the latch element preventing removal of the fuse when in a locked position. The fuse assembly may include opposing side walls, with at least one of the side walls comprising a cradle pivot slot. The mounting bracket may comprise a rail and the fuse assembly may comprise at least one support, with the fuse assembly being movable along the rail on the support. The apparatus may comprise solid dielectric switchgear. The apparatus may include a visible latch indicator.

An embodiment of a high voltage electrical apparatus is also disclosed, comprising: an enclosure; a high voltage bushing extending from the enclosure; a fuse mounting bracket coupled to the enclosure proximate the high voltage bushing, the fuse mounting bracket defining a rail; and a fuse assembly connected to the high voltage bushing and movable along the rail, the fuse assembly being positionable between a closed position supported by the rail and an open position rotated away from the rail, the assembly fuse comprising bushing interface configured for mating with the high voltage bushing and making and breaking a high voltage connection to the high voltage bushing.

Optionally, a cradle may be mounted to the enclosure, and the fuse may be supported on the cradle when rotated away from the rail. A pivotal linkage may be adapted to separate the bushing interface from the high voltage bushing under energized circuit conditions. A threaded actuator element may be adapted to separate the bushing interface from the high voltage bushing under energized circuit conditions. The fuse assembly may comprises a roller for moving the fuse assembly along the rail. The fuse removal assembly may further comprise a latch element, with the latch element preventing removal of the fuse when in a locked position. The fuse assembly may include opposing side walls, the fuse extending between the side walls, and at least one of the side walls comprising a cradle pivot. The apparatus may comprise solid dielectric switchgear. The apparatus may further comprise a visible latch indicator.

An embodiment of electrical switchgear is also disclosed, with the switchgear comprising: an enclosure; a high voltage bushing extending from the enclosure; a fuse mounting bracket coupled to the enclosure proximate the high voltage bushing, the fuse mounting bracket defining a rail; a fuse assembly connected to the high voltage bushing and positionable along the rail relative to the bushing, wherein the fuse comprises a bushing interface; a threaded actuator adapted to separate the bushing interface from the high voltage bushing while energized at high voltage; a cradle coupled to the enclosure proximate the fuse mounting bracket and adapted to support the fuse when removed from the rail; and wherein the fuse is rotatable about the cradle away from the rail to an open position wherein the fuse may be replaced.

Optionally, the switchgear may comprise solid dielectric switchgear. The switchgear may further comprise a pulling eye and a threaded shaft, with the pulling eye rotatable to turn the shaft about a longitudinal axis to move the fuse assembly along the rail. The switchgear may further comprise a visible latch indicator.

While the invention has been described in terms of various specific embodiments, those skilled in the art will recognize that the invention can be practiced with modification within the spirit and scope of the claims.

What is claimed is:

1. A deadfront electrical apparatus comprising:
an enclosure;
a high voltage bushing extending from the enclosure;
a fuse mounting bracket coupled to the enclosure proximate the high voltage bushing;
a fuse assembly connected to the high voltage bushing and being selectively positionable between a closed position supported by the mounting bracket, and an open position, the fuse comprising a bushing interface; and
a fuse removal assembly adapted to separate the bushing interface from the high voltage bushing under energized circuit conditions.

2. The apparatus of claim 1, wherein the fuse removal assembly comprises a pivotal linkage mounted to the fuse mounting bracket.

3. The apparatus of claim 1, wherein the fuse removal assembly comprises a threaded actuator element.

4. The apparatus of claim 1, wherein the fuse removal assembly further comprises a fuse cradle mounted to the enclosure adjacent the fuse bracket.

5. The apparatus of claim 1, wherein the fuse removal assembly further comprises a latch element, the latch element preventing removal of the fuse when in a locked position.

6. The apparatus of claim 1, wherein the fuse assembly includes opposing side walls and a fuse extending between the side walls, at least one of the side walls comprising a cradle pivot slot.

7. The apparatus of claim 1, wherein the mounting bracket comprise a rail, the fuse assembly being movable along the rail.

8. The apparatus of claim 1, wherein the apparatus comprises solid dielectric switchgear.

9. A high voltage electrical apparatus comprising:
an enclosure;
a high voltage bushing accessible on the enclosure;
a fuse mounting bracket coupled to the enclosure proximate the high voltage bushing;
a cradle coupled to the enclosure proximate the mounting bracket; and
a fuse assembly connected to the high voltage bushing and being selectively positionable between a closed position supported by the mounting bracket and an open position supported by the cradle, the fuse assembly comprising a bushing interface configured for making and breaking a high voltage connection to the bushing;
wherein the fuse is pivotal about the cradle to the open position.

10. The apparatus of claim 9, further comprising a pivotal linkage adapted to separate the bushing interface from the high voltage bushing under energized circuit conditions.

11. The apparatus of claim 9, further comprising a threaded actuator element adapted to separate the bushing interface from the high voltage bushing under energized circuit conditions.

12. The apparatus of claim 9, wherein the fuse assembly comprises a turning eye.

13. The apparatus of claim 9, wherein the fuse assembly further comprises a latch element, the latch element preventing removal of the fuse when in a locked position.

14. The apparatus of claim 9, wherein the fuse assembly includes opposing side walls, at least one of the side walls comprising a cradle pivot slot.

15. The apparatus of claim 9, wherein the mounting bracket comprise a rail and the fuse assembly comprises at least one support, the fuse assembly being movable along the rail on the support.

16. The apparatus of claim 9, wherein the apparatus comprises solid dielectric switchgear.

17. A high voltage electrical apparatus comprising:
an enclosure;
a high voltage bushing extending from the enclosure;
a fuse mounting bracket coupled to the enclosure proximate the high voltage bushing, the fuse mounting bracket defining a rail; and
a fuse assembly connected to the high voltage bushing and movable along the rail, the fuse assembly being positionable between a closed position supported by the rail and an open position rotated away from the rail, the assembly fuse comprising bushing interface configured for mating with the high voltage bushing and making and breaking a high voltage connection to the high voltage bushing.

18. The apparatus of claim 17, further comprising a cradle mounted to the enclosure, the fuse supported on the cradle when rotated away from the rail.

19. The apparatus of claim 17, further comprising a pivotal linkage adapted to separate the bushing interface from the high voltage bushing under energized circuit conditions.

20. The apparatus of claim 19, further comprising a threaded actuator element adapted to separate the bushing interface from the high voltage bushing under energized circuit conditions.

21. The apparatus of claim 17, wherein the fuse assembly comprises a roller for moving the fuse assembly along the rail.

22. The apparatus of claim 17, wherein the fuse removal assembly further comprises a latch element, the latch element preventing removal of the fuse when in a locked position.

23. The apparatus of claim 17, wherein the fuse assembly includes opposing side walls, the fuse extending between the side walls, at least one of the side walls comprising a cradle pivot.

24. The apparatus of claim 17, wherein the apparatus comprises solid dielectric switchgear.

25. Electrical switchgear comprising:
an enclosure;
a high voltage bushing extending from the enclosure;
a fuse mounting bracket coupled to the enclosure proximate the high voltage bushing, the fuse mounting bracket defining a rail;
a fuse assembly connected to the high voltage bushing and positionable along the rail relative to the bushing, wherein the fuse comprises a bushing interface;
a threaded actuator adapted to separate the bushing interface from the high voltage bushing while energized at high voltage;
a cradle coupled to the enclosure proximate the fuse mounting bracket and adapted to support the fuse when removed from the rail; and
wherein the fuse is rotatable about the cradle away from the rail to an open position wherein the fuse may be replaced.

26. The switchgear of claim 17, wherein the switchgear comprises solid dielectric switchgear.

27. The switchgear of claim 17, wherein the switchgear further comprises a pulling eye and a threaded shaft, the pulling eye rotatable to turn the shaft about a longitudinal axis to move the fuse assembly along the rail.

28. The apparatus of claim 1, wherein the fuse removal assembly further includes a visible latch indicator.

29. The apparatus of claim 9, further comprising a visible latch indicator.

30. The apparatus of claim 17, further comprising a visible latch indicator.

31. The switchgear of claim 25, further comprising a visible latch indicator.
